(19) United States
(12) Patent Application Publication
(10) Pub. No.: US 2010/0158457 A1
(43) Pub. Date: Jun. 24, 2010

(54) RUGGEDIZED, LIGHTWEIGHT, AND COMPACT FIBER OPTIC CABLE

(75) Inventors: Michael Drozd, Hamden, CT (US); Russell Isch, Tolland, CT (US); Tristan Maneja, Meriden, CT (US); Robert Wiggin, Middletown, CT (US)

Correspondence Address: BLANK ROME LLP, WATERGATE, 600 NEW HAMPSHIRE AVENUE, N.W., WASHINGTON, DC, 20037, US

(73) Assignee: Amphenol Corporation, Wallingford, CT (US)

(21) Appl. No.: 12/339,898

(22) Filed: Dec. 19, 2008

(51) Int. Cl. G02B 6/44

(52) U.S. Cl. 385/113

(57) ABSTRACT

A fiber optic cable is described. The fiber optic cable includes optical fibers, a matrix substantially encasing the optical fibers, a tape substantially around the matrix, a tube substantially around the tape, a strength member around the tube, and a jacket substantially on an outer periphery of the fiber optic cable.

### FIELD OF THE INVENTION

The present invention relates to fiber optic cables. More particularly, the present invention relates to ruggedized, lightweight, and compact fiber optic cables with high tensile strength and flexibility that can be used outdoors and in harsh environments and resists crushing, impacting, kinking, and torquing.

### BACKGROUND OF THE INVENTION

Fiber optic cables transmit data by using light signals instead of electrical signals. By using light signals, fiber optic cables provide more data capacity, less signal attenuation, and greater immunity to noise and interference than other kinds of cables. Another advantage of fiber optic cables is that they are lighter and smaller than other types of cables. Consequently, fiber optic cables are used for a variety of applications requiring lightweight and compact cables. An example of such an application is the military's rapidly deployable communication and data network where cables are deployed from backpacks and connected between locations in many different environments.

A fiber optic cable that can be used with rapidly deployable networks must be, at least, lightweight and rugged. Because the cable may be deployed by an individual carrying the cable in a backpack, the cable must be lightweight so that greater lengths of cable can be deployed with less fatigue on the individual deploying the cable. Also, the fiber optic cable must be mechanically sturdy because the cable may be exposed to harsh environmental conditions. However, the optical fibers that transmit the light signal within the fiber optic cable require materials that are transparent to light, and often the desired transparent materials are highly susceptible to damage from mechanical loading, impact, heat, and other potential sources of damage. Typically, the optical fibers are made from glass fibers which are inherently fragile. Fragile glass fibers render it difficult to form a flexible cable that can withstand bending, twisting, mechanical impacting, vibration, and other types of stress because glass fibers typically fail due to twisting, bending, or crushing of the optical cable. Furthermore, damage due to localized high stress concentrations can occur during installation and use, such as when the cable is bent over sharp objects, clamped too tightly, struck by another object, twisted, or bent beyond its minimum bend radius. Thus, it is necessary that the optical fibers be protected from external forces which can damage the optical fibers while at the same time providing a flexible fiber optic cable.

Some conventional cables use metal tubes and stranding to protect the optical fibers. One such cable is described in EP 1679534 which provides a relatively strong cable with a compact size of 3.8 mm in diameter. However, the tubes and stranding increase the cost of manufacturing and add significant weight to the cable of EP 1679534. The tube construction also weakens the overall strength, impact resistance, crush resistance, and kink resistance of the cable.

Tubes are often used to provide robustness in fiber optic cable designs. For example, U.S. Pat. No. 6,249,629 to Bringuier discloses a fiber optic cable having a plurality of tubes each having at least one optical fiber therein. At least one strength component is included in the inner core of the cable along with the tubes. The inner core is held together with a binder tape. The cable of Bringuier also includes a durable jacket formed from polyethylene or other material that is suitable for the cable's application. The cable of Bringuier is manufactured with a generally round profile with an outer diameter preferably around 10.5 mm. However, to maximize the ability of a cable to be deployed in the field, a cable with a significantly smaller diameter is desirable.

Tubing is also used in DE 19900218 which describes an optical fiber cable shielded and protected by a gel, a metal tube, tensile fibers and a fire resistant outer sheath. The cable of DE 19900218 is designed to provide an indoor communications cable with extended fire resistance. However, the metallic tubing and gel result in a cable that is larger, less flexible, more prone to compressive and impact damage, and more costly to manufacture.

U.S. Pat. No.6,233,384 to Sowell, III et al. describes a “Ruggedized Fiber Optic Cable” that is crush, kink, and torque resistant. The cable of Sewell, III et al. has a single optical fiber wrapped in several layers of material including (1) a buffering layer of expanded polytetrafluoroethylene (PTFE), (2) an extruded polymer layer of PTFE, (3) a helically or spirally wrapped polymer layer, (4) a rigid helically or spirally wrapped wire made of stainless steel or similar hard material, (5) a mechanical braid formed from silver plated copper, and (6) an extruded outer jacket that can be made from PTFE, fluorinated ethylene propylene (FEP), perfluoroalkoxy (PFA), polyvinylchloride (PVC), or polyurethane. Another embodiment described by Sewell, III et al. has nine layers of coating material. Although the cable of Sewell, III et al. provides protection for a single optical fiber, most applications require several optical fibers. Also, the many different layers and materials required by the cable of Sewell, III et al. increases the cost, weight, and size of the cable.

To protect data transmitting optical fibers, U.S. Pat. No. 4,909,591 to Capol describes using at least one cylinder-shaped shell that is bounded on its inside and its outside by two cylindrical pipes with fixed links installed in the space between the outer wall of the inner pipe and the inner wall of the outer pipe. The fixed links are connected to each other in the longitudinal direction of the cable by a rubber-like band located near the inner wall of the outer pipe. To manufacture the cable of Capol, several extruders (five are illustrated in FIG. 1 of Capol) are required as well as complex mechanisms for inserting, conveying, and guiding. Thus, the cable of Capol and the method of manufacturing the cable of Capol are significantly more complex and expensive and do not protect optical fibers under extreme working conditions.

U.S. patent application Ser. No. 10/775,585, filed Feb. 10, 2004, by Anderson et al. and published as U.S. Patent Application Pub. No. 2004/0190841 describes “Low Smoke, Low Toxicity Fiber Optic Cable.” The cable of Anderson is intended for applications in the commercial and military aerospace industry and has features to meet standards for smoke and toxic gas emission, cable jacket shrinkage, and finished cable attenuation. The cable lacks features to provide high tensile strength and crush resistance. In one embodiment, it has a single optical fiber with primary and secondary buffers, and the secondary buffer has an outer diameter of about 850 μm to 900 μm. The outer protective jacket of the cable has a wall thickness ranging from about 150 μm to 200 μm, and the overall outer diameter of the Anderson cable is about 1.8 mm to 2.0 mm. With the construction described, the cable of Anderson does not reduce microbending of optical fibers caused by impact, compression, and/or tensile load.

There is therefore a need in the art for a ruggedized, lightweight, compact cable, with reduced microbending attenuation losses. Particular needs remain for a cable that has high tensile strength, flexibility, crush resistance, impact resistance, kink resistance, and torque resistance with no metallic components. Without metallic components, the cable can resist damage to itself and connected equipment from lightning strikes and avoid discovery by metal detection devices.

### SUMMARY OF THE INVENTION

Accordingly, an aspect of the invention provides a fiber optic cable that is ruggedized, lightweight, and compact with no metallic components.

One embodiment of the invention provides a fiber optic cable. The fiber optic cable includes optical fibers, a matrix substantially encasing the optical fibers, a tape substantially around the matrix, a tube substantially around the tape, a strength member substantially around the tube, and a jacket substantially on an outer periphery of the fiber optic cable. The matrix moves relative to the tape.

Another embodiment of the invention provides a fiber optic cable. The fiber optic cable includes optical fibers, a matrix substantially encasing the optical fibers, a tape substantially around the matrix, a water swellable yarn substantially helically wound around the tape, a tube substantially disposed around the water swellable yarn, a strength member substantially around the tube, and a jacket substantially on an outer periphery of the fiber optic cable. The matrix moves relative to the tape.

Yet another embodiment of the invention provides a fiber optic cable. The fiber optic cable includes optical fibers, a matrix encasing the optical fibers, an expanded polytetrafluoroethylene (ePTFE) tape substantially around the matrix, a tube substantially around the expanded polytetrafluoroethylene tape, a strength member substantially around the tube, and a jacket substantially on an outer periphery of the fiber optic cable. The matrix includes an ultraviolet-curable elastomeric acrylate, and the tube includes a fluoropolymer. The strength member includes aramid yarn substantially helically placed on the tube.

Other objects, advantages and salient features of the invention will become apparent from the following detailed description, which, taken in conjunction with the annexed drawings, discloses a preferred embodiment of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a partial perspective view of a fiber optic cable according to an exemplary embodiment of the invention, various layers of the cable being exposed for the purposes of illustration;

FIG. 2 is a sectional view taken substantially along line 2-2 of the fiber optic cable illustrated in FIG. 1;

FIG. 3 is a schematic diagram illustrating a tape wrapping sequence in the manufacturing of the fiber optic cable illustrated in FIG. 1;

FIG. 4 is a schematic diagram illustrating a jacket application sequence in the manufacturing of the fiber optic cable illustrated in FIG. 1;

FIG. 5 is a schematic diagram illustrating a strength member application sequence in the manufacturing of the fiber optic cable illustrated in FIG. 1;

FIG. 6 is a schematic diagram illustrating a second jacket application sequence in the manufacturing of the fiber optic cable illustrated in FIG. 1; and

FIG. 7 is a schematic illustrating a rolling flex test apparatus.

### DETAILED DESCRIPTION OF THE INVENTION

In describing an embodiment of the invention illustrated in the drawings, specific terminology will be resorted to for the sake of clarity. However, the invention is not intended to be limited to the specific terms so selected, and it is to be understood that each specific term includes all technical equivalents that operate in a similar matter to accomplish a similar purpose.

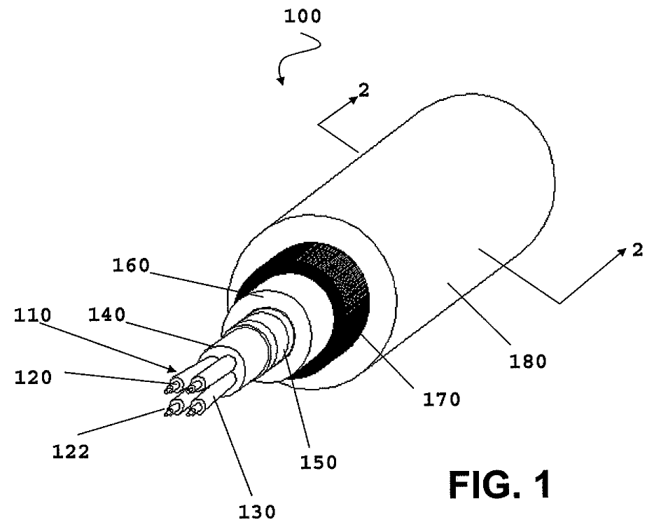

As shown in FIGS. 1-7 the invention relates to a fiber optic cable 100 that is rugged, lightweight, and compact. Referring to FIG. 1, a partial perspective view of the fiber optic cable 100 is shown. The fiber optic cable 100 includes a multiplicity of optical fibers 110. Each optical fiber 110 is substantially surrounded by a protective coating 130, and the optical fibers 110 are generally surrounded by a matrix 140. A tape 150 substantially surrounds the matrix 140, and a tube 160 substantially surrounds the tape 150. A strength member 170 is generally around the tube 160, and an outer jacket 180 substantially surrounds the strength member 170.

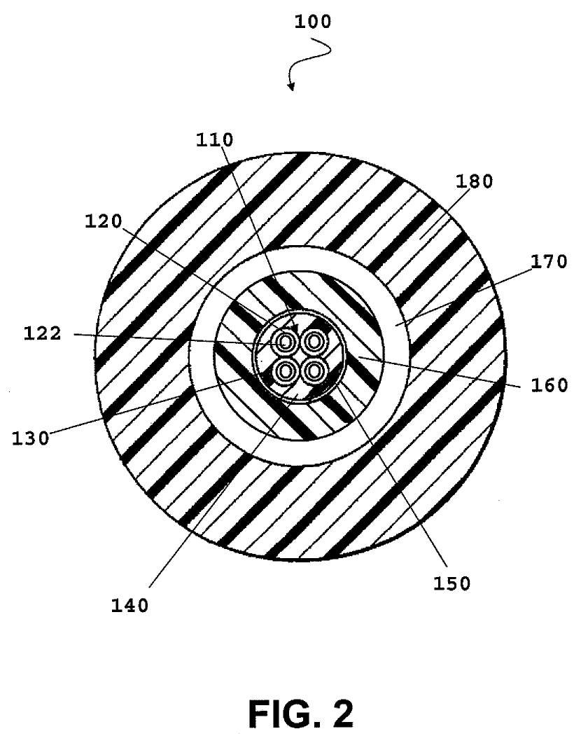

The optical fiber 110 transmits light signals. To facilitate the description of the invention without intending to limits its scope, the term “light” is used to mean any form of electromagnetic radiation and not merely electromagnetic radiation within the visible light spectrum. Each optical fiber 110 includes a light-transmitting core 122 and a cladding 120 that substantially surrounds the core 122. The core 122 and the cladding 120 are made from generally transparent material, however the cladding 120 has a lower refractive index than the core 122 and can thus substantially confine the light within the core 122. The optical fibers 110 can be made from polymethyl methacrylate (PMMA), polymethylacrylate, polimide, acrylate, other plastics, glass, combinations of the aforementioned, or other substantially transparent materials. The optical fibers 110 can be commercially available fibers and can be of any design such as optical fibers classified as standard fiber, radiation hardened fiber, glass fiber, plastic optical fiber (POF), polyimide fiber, acrylate fiber, hermetically sealed, carbon coated, or any other optical fiber. The optical fiber 110 can be single-mode optical fiber, multi-mode optical fiber, or any other optical fiber. In the embodiment shown, the cable 100 includes four optical fibers 110; however the number of optical fibers 110 shown is not meant to be limiting. The optimal number of optical fibers 110 may be more or less than the four shown in FIGS. 1-2. For example, in alternate embodiments, the cable 100 can have two to twelve or more optical fibers 110.

Each optical fiber 110 is substantially covered by the protective coating 130. The protective coating 130 generally surrounds the cladding 120, and the coating 130 provides mechanical protection for the optical fiber 110. In the embodiment shown, the coating 130 is a plastic layer applied over the cladding 120. The coating can also identify the optical fiber 110 by color, marking, or some other identifying device.

The optical fibers 110 are substantially encased in the matrix 140. The matrix 140 can be easily stripped from the optical fibers 110 so that the optical fibers 110 can be terminated to an optical fiber connector. In the embodiment shown, the matrix 140 is made from elastomeric acrylate and is disposed on the optical fibers 110 through a bonding process. In the bonding process, a group of optical fibers 110 are coated with a liquid, ultraviolet-curable (UV-curable) acrylate. After excess liquid, UV-curable acrylate is removed, the optical fibers 110 are exposed to ultraviolet light to cure the liquid acrylate, thus forming a group of optical fibers 110 encased in a matrix 140. The matrix 140 can be a single layer or multiple layers of elastomeric acrylate. In the embodiment shown, the matrix 140 is made from Cablelite 3287-9-41 manufactured by DSM Desotech Inc., 1122 St. Charles Street, Elgin, Ill. 60120. Cablelite 3287-9-41 is a soft, high-elongation matrix material with a fast cure speed.

The tape 150 substantially surrounds the matrix 140 which encases the optical fibers 110. The tape 150 generally reduces microbending of the optical fibers 110 by allowing the matrix 140 to move relative to the tape 150 to relieve stress caused by expansion and contraction of the jacket 180 due to changes in temperature which causes microbending attenuation losses. Thus, because the tape 150 relieves stress and generally reduces microbending, the tape 150 provides the cable 100 with lower attenuation losses when compared to other cables. In the embodiment shown, the tape 150 is a fluoropolymer tape, and in particular, an expanded polytetrafluoroethylene (ePTFE) tape which is approximately 0.05 mm to approximately 0.10 mm in thickness and approximately 3 mm to approximately 6 mm in width. The tape 150 is applied with a right-hand lay with an overlap of about 20% to about 40%. In an alternative embodiment the tape 150 can have a left-hand lay, a different amount of overlap, or be applied through cigarette wrapping where the tape 150 is a generally flat sheet that is wrapped longitudinally around the matrix 140.

The tube 160 substantially surrounds the tape 150. In the embodiment shown, the tube 160 is made from semi-pressure-extruded flouropolymer that is extruded around the tape 150. In the embodiment shown, the tube 160 is made from polyvinylidene fluoride (PVDF), such as DYNEON™ PVDF 32008/0009 or an equivalent that is designed for high speed extrusion and can be processed using a variety of thermoplastic conversion techniques. The PVDF can be an ultra-flexible copolymer of VF₂ and CTFE, thus exhibiting very low shrinkage and excellent impact resistance.

The strength member 170 substantially surrounds the tube 160 and provides mechanical support for the cable 100. The strength member 170 substantially bears tensile loads so that largely no load is placed on the optical fibers 110 when the cable 100 is in tension. The strength member 170 also generally mitigates stress placed on the optical fibers 110 during bending and twisting of the cable 100. In the embodiment shown, the strength member 170 is made from aramid yarn that is helically wound around the tube 160 and has a substantially consistent lay about the approximate center of the cable 100. The lay length is approximately 90 mm (approximately 3.5 inches). The lay of the strength member 170 is opposite the lay of the tape 150, however, in other embodiments, the lay of the strength member 170 can be the same as the lay of the tape 150.

The jacket 180 substantially surrounds the strength member 170 and provides mechanical support for the cable 100. The jacket 180 provides a protective outer covering for the cable 100. The material used for the jacket 180 varies with the intended use and the environment within which the cable 100 operates. For example, for harsh environments, the jacket 180 is formed from polyether-based thermoplastic polyurethane (TPU). TPU is used because it provides abrasion resistance, toughness, desired low temperature properties, hydrolytic stability, and fungus resistance. If TPU is used for the jacket 180, the hardness of TPU may permissibly range from approximately 60 Shore A to approximately 74 Shore D. In one embodiment, the hardness of a jacket 180 made of TPU is approximately 64 Shore D because 64 Shore D provides the desired combination of flexibility and toughness. In the embodiment shown, the jacket 150 is made from Elastollan 1164D50 polyether type polyurethane.

For applications where the cable 100 must satisfactorily meet UL-910 (plenum) burn performance testing, such as for indoor or outdoor use, the jacket 180 can be made from polyvinylidene fluoride (PVDF), such as DYNEON™ LLC CTFE Copolymer 31008/0009. For applications requiring satisfactory performance under UL-1666 (riser) burn performance testing, such as for indoor use, the jacket 150 can be formed from polyvinyl chloride (PVC), thermoplastic, or halogen-free, fire-retardant, cable-sheathing compound. Suitable PVC and other halogen-free, fire retardant jacketing compounds are available from AlphaGary Corporation, 170 Pioneer Drive, Leominster, Mass. 01435 or Teknor Apex, Inc., 505 Central Avenue, Pawtucket, R.I. 02861.

In the embodiment shown, pressure extrusion disposes the jacket 180 onto the cable 100. In alternative embodiments, the jacket 180 can be applied using a tubing technique where the cable 100 is pulled through a conically-shaped extruded tube to dispose the jacket 180 onto the cable 100.

Referring to FIG. 2, the depicted cable 100 has a generally round cross-sectional shape. If the cable 100 does not have the optical fibers 110, the coating 130, the matrix 140, the tape 150, the tube 160, or the strength member 170 as shown in FIGS. 1-2 and thus does not have a generally round cross-sectional shape, the strength member 170 is adjusted so that the cable 100 attains a generally round cross-sectional shape. The optimal configuration of the optical fibers 110, the coating 130, the matrix 140, the tape 150, the tube 160, and the strength member 170 are determined based on desired characteristics, such as, crush resistance, tensile strength, flexure, weight, size, flame resistance, cost, and/or other cable characteristics. In the embodiment shown, the cable 100 has an outer diameter of approximately 3.8 mm or less.

For applications where the cable 100 must exceed the requirements of TIA-455-82B for resistance to fluid penetration, a water blocking member, such as water swellable yarn, (not illustrated) is provided. In an embodiment with water swellable yarn, the water swellable yarn can be spirally wound around the tape 150. Suitable water swellable yarn can be made from polyester yarn, super-absorbent materials, or a binder. One such suitable water swellable yarn is WBY220 manufactured by Neptco Inc., 30 Hamlet Street Pawtucket, R.I. 02861. In alternative embodiments, the water blocking member can be a water swellable substance, such as, super-absorbent fibers stranded with polyester fibers, a yarn impregnated with a super-absorbent polymer (SAP), an aramid yarn impregnated with SAP, or other similar water blocking materials.

The construction of the cable 100 can provide simpler and lower cost manufacturing because the construction allows formation of one or more subcomponents. The optical fibers 110, the coating 130, the matrix 140, the tape 150, the tube 160, the strength member 170, and water blocking member, if required, can be made together as a subcomponent, and then the jacket 180 can be applied in a separate manufacturing process.

To manufacture the cable 100, optical fibers 110 are provided. The optical fibers 110 are substantially encased in the matrix 140. In the embodiment shown, the optical fibers 110 are encased in an elastomeric acrylate matrix 140 using a bonding process. In the bonding process, the optical fibers 110 are coated with liquid, UV-curable acrylate. After excess liquid, UV-curable acrylate is removed, the optical fibers 110 are exposed to UV light to cure the acrylate. The matrix 140 can be made from one or more applications of elastomeric acrylate. The optical fibers 110 encased in the matrix 140 are substantially wrapped with the tape 150. In the embodiment shown, the tape 150 is a fluoropolymer tape, such as ePTFE tape, which allows the matrix 140 to move relative to the tape 150 and thus substantially reduces microbending and thereby substantially reduces attenuation losses. The tape 150 is then largely covered with the tube 160. In the embodiment shown, a semi-pressure extruded fluoropolymer, such as PVDF, is extruded around the tape 150 to form the tube 160. The strength member 170 is substantially placed around the tube 160. In the depicted embodiment, the strength member 170 is made from aramid yarn helically laid along the tube 160. The jacket 180 is then placed around the strength member 170. In the embodiment shown, the jacket 180 is placed on the strength member 170 by pressure extrusion. In other embodiments, the jacket 180 can be formed generally as a hollow tube that is placed on the strength member 170 for easier stripping of the jacket 180. The jacket 180 is made from a material that is generally selected based on the intended use of the cable 100. The jacket 180 can be made from TPU; PVDF; PVC; a halogen-free, fire-retardant, cable-sheathing material; cross-linked polyethylene (PE); polyurethane (PU); thermoplastic elastomers (TPO); or some other suitable material.

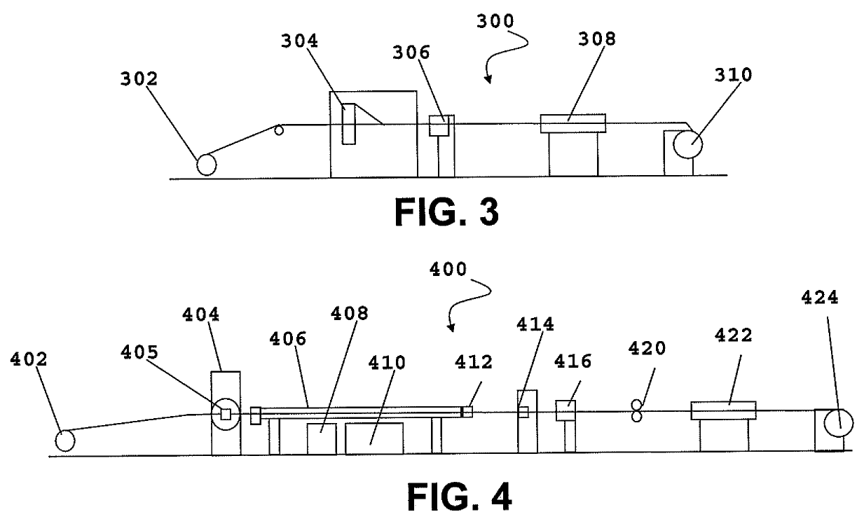

Referring to FIGS. 3-6, schematic diagrams are shown to illustrate the manufacturing of fiber optic cable 100 according to the embodiment shown in FIGS. 1-2. In FIG. 3, the wrapping process 300 or the application of the tape 150 substantially around the optical fibers 110 encased in the matrix 140 is shown. In the figure, ePTFE tape is applied. A payoff section 302 feeds under tension the optical fibers 110 encased in the matrix 140. A wrapping head 304 applies the tape 150 to the matrix 140 by wrapping the tape 150 around the matrix 140. The wrapping head 304 can be adjusted to apply a right-hand lay or a left-hand lay with a predetermined lay length and a predetermined overlap. Component 306 controls the wrap tension via a diameter gage. A caterpuller 308 pulls the wrapped fibers 310 and matrix 340 through the wrapping process 300. A take-up section 310 rolls the wrapped fibers 110 and matrix 140 onto a reel.

Turning to FIG. 4, an extrusion process 400 is shown. In the embodiment shown, the tube 160 is applied. At a payoff section 402, the output from the wrapping process 300 is delivered to the extrusion process 400. The payoff section 402 can have an adjustable setting for tension. At an extrusion section 404, the tube 160 is semi-pressure extruded around the output from the payoff section 402. The extruder section 404 can have an adjustable setting for the temperature of the extruded material, the pressure for extrusion, and the speed of extrusion. The extruder section 404 can have a crosshead 405. The output from the extruder section 404 is delivered to a quench section which can include a quench trough 406, a temperature controller 408, a tank 410, and an air wipe 412. The quench section cools the extruded material, for example, by submerging the molten extruded material in water and then air drying the cooled, extruded material. A print section 414 is shown but is not used for the embodiment described. A diameter gage 416 verifies the dimensions of the extruded tube 160. A length counter 420 measures the length of the output from the extrusion process 400. Another caterpuller 422 pulls the subassembly through the extrusion process 400, and a take-up section 424 rolls the subassembly onto a reel.

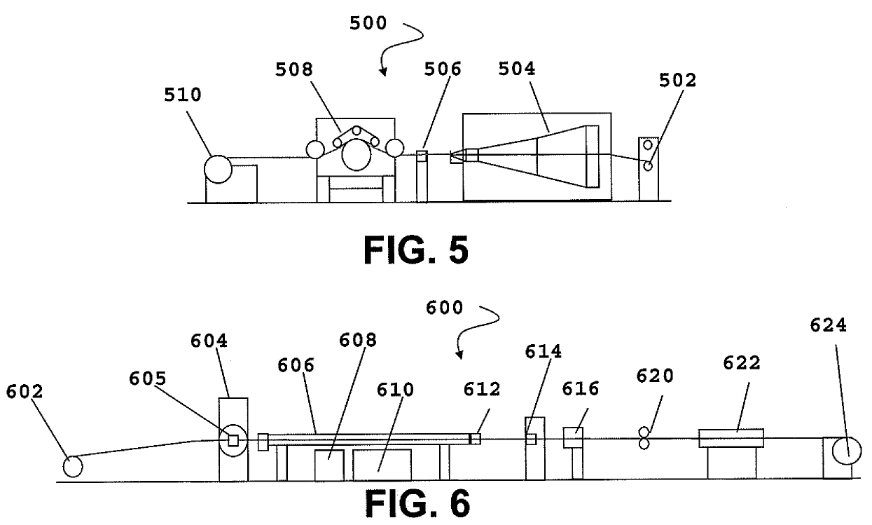

Referring to FIG. 5, a stranding process 500 is shown schematically. In the embodiment shown, the strength member 170 is applied. At a payoff section 502, the output from the extrusion process 400 is delivered to the stranding process 500. At a stranding station 504, the strength member 170 is helically wrapped around the output from the extrusion process 400. The stranding section 504 can have controls for line speed and lay length. For the cable 100 as shown in FIGS. 1-2, the lay length is approximately 90 mm (approximately 3.5 inches). A diameter gage 506 verifies the dimensions of the strength member 170. A capstan 508 pulls the subassembly through the stranding process 500, and a take-up section 510 rolls the subassembly onto a reel.

Referring to FIG. 6, an extrusion process 600 is shown schematically. In the embodiment shown, the extrusion process 600 places the jacket 180 substantially around the strength member 170. At a payoff section 602, the output of the stranding process 500 is delivered to the extrusion process 600. At an extrusion section 604, material to form the jacket 180 is pressure extruded around the strength member 170. The extruder section 604 can have adjustable settings for the temperature of the extruded material, the pressure for extrusion, and the speed of extrusion. The extruder section 604 can have a crosshead 605. The output from the extruder section 604 is delivered to a quench section which can include a quench trough 606, a temperature controller 608, a tank 610, and an air wipe 612. The quench section cools the extruded material, for example, by submerging the molten extruded material in water and then air drying the cooled, extruded material. A print section 614 applies predetermined markings on the jacket 180. A diameter gage 616 verifies the dimensions of the jacket 180. A length counter 620 measures the length of the cable 100. A caterpuller 622 pulls the subassembly through the extrusion process 600, and a take-up section 624 rolls the cable 100 onto a reel.

A description of one exemplary embodiment follows, but the described embodiment is not intended to be limiting. The described embodiment is provided to illustrate the advantages of the invention and for comparison purposes. The exemplary embodiment has four optical fibers 110 with each optical fiber 110 having a numerical aperture of approximately 0.20±0.020 to approximately 0.20±0.015, an approximately 50±3 μm core 122, an approximately 125±3 μm cladding 120, and an approximately 250±15 μm protective coating 130. The optical fibers 110 of the exemplary embodiment are encased in a matrix 140 made of an elastomeric acrylate, such as Cablelite 3287-9-41. The exemplary embodiment has tape 150 made of expanded PTFE of about 0.1 mm thickness and about 4.75 mm width. A PVDF tube 160, such as one made from DYNEON™ PVDF 32008/0009, substantially surrounds the optical fibers 110 with coating 130 encased in the matrix 140 and the tape 150. The strength member 170 of the exemplary embodiment is made from aramid yarn (1610 dtex). The jacket 180 of the exemplary embodiment is made of polyurethane with a nominal wall thickness of approximately 0.7 mm and a jacket concentricity of about ≧65% per MIL-PRF-85045F. The overall outer diameter of the exemplary embodiment is approximately 3.8±0.15 mm.

The exemplary embodiment of the cable 100, as described above and as shown in FIGS. 1-2, has a maximum weight of no more than about 15 kg/km. At about 25° C. and about 80% relative humidity, the exemplary embodiment meets or exceeds the allowable attenuation per TL6020-003, that is, attenuation is limited to ≦3 dB/km at 850 nm and to ≦1 dB/km at 1300 nm. The exemplary embodiment meets or exceeds the bandwidth requirements of ITU-T G.651 (per TL6020-003) and provides a minimum bandwidth of at least approximately 500 MHz-km at both 850 nm and 1300 nm for optical fiber with a 50 μm core.

The exemplary embodiment of the cable 100 has a maximum operating load of greater than about 1,600 N as determined under IEC794-1-E1 which measures attenuation in the optical fibers as a function of the load on the fiber optic cable. The exemplary embodiment can provide optical transmission up to a breaking point that is ≧3,400 N and in particular, a breaking strength of approximately 3,780 N.

Also, the exemplary embodiment has a crush resistance of greater than approximately 1,400 N/cm with substantially no change in attenuation, as tested per IEC794-1-E1 which determines the ability of a fiber optic cable to mechanically and optically withstand and recover from the effects of a slowly applied compressive force After the test, the jacket 180 exhibited no visual evidence of cracking, splitting, or other damage. The exemplary embodiment has a crush resistance of greater than 14,000 N/cm with about a 0.2 dB change in the attenuation when the load is applied and held for approximately 3 minutes which meets or exceeds the requirements of MIL-PRF-85045, “Performance Specification for Fiber Optic Cables,” which requires the cable to be exposed to a compressive load not less than 2,000 N/cm of outer cable diameter held for three minutes and released. Under MIL-PRF-85045, the maximum change in absolute attenuation for tactical multimode cables must be ≦0.5 dB, and for tactical single mode cables, the maximum change in absolute attenuation must be ≦0.3 dB.

The exemplary embodiment can resist 100 impacts of 2.21 N-m, as measured per TIA/EIA-455-25C (FOTP-25) which determines the ability of an optical fiber to withstand impact loads by dropping a test hammer on the cable. After testing, the jacket 180 exhibited no visible evidence of cracking, splitting, or other damage.

The exemplary embodiment passes the torsion test of IEC794-1-E7 which measures any variation in the optical power transmittance of an optical fiber when the cable is subjected to external torsional forces. In the test, one end of a one-meter portion of the cable 100 is clamped to one stationary gripping device, while the opposite end is clamped to a gripping device that can be rotated. The rotating gripping device is rotated 180° clockwise, returned to its original position, rotated 180° counterclockwise, and then returned to its original position to complete one cycle of testing. The one-meter sample is cycled six times while subjected to a 100 N tensile force. A visual examination of the jacket 180 after testing revealed no cracking, splitting, or other damage. The attenuation of the exemplary embodiment only changes by about 0.1 dB during testing and is substantially 0.0 dB when released.

The exemplary embodiment has a bend radius of approximately 5× the outer diameter with no tensile load and a bend radius of approximately 13× the outer diameter with tensile load. The exemplary embodiment passes the kink resistance test of IEC794-1-E10 which determines the minimum loop diameter at which an optical fiber cable begins to kink. Testing indicates the exemplary embodiment has a minimum bend radius of approximately 6.5 mm with a reversible 0.2 dB change in attenuation. At approximately 6.5 mm, there is no kinking. The exemplary embodiment passes the static bending strength test of IEC794-1-E11/Procedure 1 which measures the ability of an optical fiber cable to withstand bending around a test mandrel. To pass, the cable must exhibit a change in attenuation that is ≦0.1 dB irreversible and ≦0.2 dB reversible.

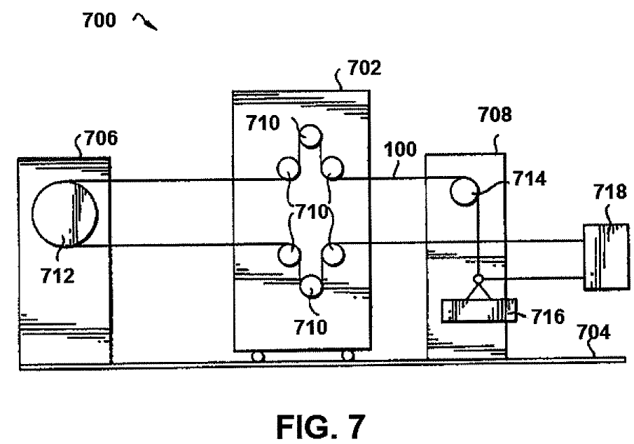

The exemplary embodiment passes the cyclic flexing test of IEC794-1-E6 which determines the effects of repeated flexions on a fiber optic cable. The exemplary embodiment can withstand 4,000 cycles of a 100 N load with a change in attenuation ≦0.2 dB and no visible damage to the jacket 180. The exemplary embodiment passes a rolling flex test and has the ability to withstand serpentine flexing for 200 cycles. Referring to FIG. 7, a rolling flex test apparatus 700 is shown. A carriage 702 travels approximately 203 cm (approximately 80 inches) on a track 704 as it moves from stand 706 to stand 708. Pulleys 712 and 714 are mounted on stands 706 and 708, respectively, allowing positioning of the cable being tested in the rolling flex test apparatus 700. One cycle is completed when the carriage 702 travels in one direction and then returns to its starting position on the track 704. The cable 100 is wound around redirecting roller 710 and pulleys 712 and 714. Tension is placed on one end of the cable 100 by a 10 kilogram weight 716, while the other end of the cable 100 is attached to a monitoring unit 718. The monitoring unit 718 monitors the real time changes in attenuation in the test cable 100. After 200 cycles, the maximum change in attenuation from the starting measured attenuation is 0.03 dB, and the jacket 180 showed no visible cracking, splitting, or other damage. The test data is below. The column entitled “dB Delta from Start” provides the change in attenuation relative to the measured attenuation at the start of the test.

| Cycles | dB Delta from Start |
|---|---|
| Initial - Unloaded | 0.00 dB |
| Start - Loaded | −0.13 dB |
| 10 | −0.11 dB |
| 20 | −0.16 dB |
| 30 | −0.18 dB |
| 40 | −0.14 dB |
| 50 | −0.06 dB |
| 60 | −0.13 dB |
| 70 | −0.07 dB |
| 80 | −0.09 dB |
| 90 | −0.17 dB |
| 100 | −0.22 dB |
| 110 | −0.16 dB |
| 120 | −0.21 dB |
| 130 | −0.21 dB |
| 140 | −0.19 dB |
| 150 | −0.20 dB |
| 160 | −0.30 dB |
| 170 | −0.22 dB |
| 180 | −0.19 dB |
| 190 | −0.27 dB |
| 200 | −0.21 dB |
| Finish - Unloaded | +0.03 dB |
| | α Δ from Initial Unloaded |

The exemplary embodiment of the cable 100 has a temperature rating of about −50° C. to about +85° C. while operating and about −60° C. to about +85° C. while in storage. The exemplary embodiment can maintain signal continuity when subjected to a flame with a controlled heat output corresponding to a temperature of at least 750° C. as required under IEC 60331-25.

As discussed above, some conventional cables use metal tubes and stranding to protect optical fibers, and one example is described in EP 1679534 which provides a relatively strong cable with a diameter of 3.8 mm. As shown in FIG. 5 of EP 1679534, the cable includes tubes and stranding. The tubes and stranding increase the cost of manufacturing and add significant weight to the cable of EP 1679534. The use of tubes also weakens the overall strength, impact resistance, crush resistance, and kink resistance of the cable. For purposes of illustrating the advantages of the exemplary embodiment to the cable of EP 1679534, the following table comparing the characteristics of said cables is provided below.

| | | Cable According to an |
|---|---|---|
| | Cable of EP | Exemplary Embodiment |
| | 1679534 | of the Invention |
| Cable Manufacturer & | Brugg | Amphenol |
| Part Number | LLK-ML-4F | 163-1199-994 |
| Number of Optical Fibers | 4 | 4 |
| Fiber Core Size | 50 μm | 50 μm |
| Cable Diameter | 3.8 mm | 3.8 mm |
| Cable Weight | 21 kg/km | 13.1 km/kg |
| Minimum Bend Radius | 35 mm | 6.5 mm |
| | | (as determined by a |
| | | Kink Test) |
| Average Breaking Load | 3000 N | 3780 N |
| Maximum Tensile | 1600 N (Change | 1600 N |
| Strength | in Attenuation | (Change in Attenuation |
| | ≦1 dB/km) | ≦0.05 dB/km) |
| Crush Resistance | 1200 N/cm | 1400 N/cm |
| | | (14,000 N/cm with a |
| | | Change in Attenuation of |
| | | 0.2 dB) |
| Impact Resistance | Resists 100 impacts | Resists 100 impacts of |
| | of 1 N-m | 2.21 N-m |
| Cyclic Bending (100 N) | 2000 cycles | 4000 cycles |
| Operating Temperature | −55° C. to +85° C. | −50° C. to +85° C. |
| Storage Temperature | −60° C. to +85° C. | −60° C. to +85° C. |
| Metallic Components | Yes | No |
| Gel-filled | Yes | No |
| Rolling Flex Test | Not Applicable | After 200 cycles, |
| | Exceeds Min | maximum change in |
| | Bend Radius | attenuation from the |
| | | starting measured |
| | | attenuation is 0.03 dB, |
| | | and the jacket 150 |
| | | showed no visible |
| | | cracking, splitting, or |
| | | other damage. |

As apparent from the above description, the invention provides a fiber optic cable that is ruggedized, lightweight, compact with no metallic components, and reduces microbending. The cable also has high tensile strength, flexibility, crush resistance, impact resistance, kink resistance, and torque resistance with no metallic components. Without metallic components, the cable can resist damage to itself and connected equipment from lightning strikes and avoid discovery by metal detection devices.

While a particular embodiment has been chosen to illustrate the invention, it will be understood by those skilled in the art that various changes and modifications can be made therein without departing from the scope of the invention as defined in the appended claims.

1. A fiber optic cable, comprising:
a plurality of optical fibers;
a matrix substantially encasing the plurality of optical fibers;
a tape substantially disposed around the matrix;
a tube substantially disposed around the tape;
a strength member substantially disposed around the tube; and
a jacket substantially on an outer periphery of the fiber optic cable, wherein the matrix moves relative to the tape.

2. A fiber optic cable according to claim 1, wherein the matrix is formed from elastomeric acrylate.

3. A fiber optic cable according to claim 1, wherein the tape is a fluoropolymer tape.

4. A fiber optic cable according to claim 1, wherein the tape is expanded polytetrafluoroethylene (ePTFE) tape.

5. A fiber optic cable according to claim 1, wherein the tube includes a flouropolymer.

6. A fiber optic cable according to claim 1, wherein the tube includes polyvinylidene fluoride (PVDF).

7. A fiber optic cable according to claim 1, wherein the strength member includes a plurality of aramid yarn.

8. A fiber optic cable according to claim 1, wherein the strength member is disposed with a lay length of approximately 90 mm (approximately 3.5 inches).

9. A fiber optic cable according to claim 1, wherein the jacket is made from any one of polyether-based thermoplastic polyurethane (TPU), polyvinylidene fluoride (PVDF), polyvinyl chloride (PVC), or halogen-free, fire-retardant, cable-sheathing compound.

10. A fiber optic cable according to claim 1, further comprising water swellable yarn substantially helically wound around the tape.

11. A fiber optic cable, comprising:
a plurality of optical fibers;
a matrix substantially encasing the plurality of optical fibers;
a tape substantially disposed around the matrix;
a water swellable yarn substantially helically wound around the tape;
a tube substantially disposed around the water swellable yarn;
a strength member substantially disposed around the tube; and
a jacket substantially on an outer periphery of the fiber optic cable, wherein the matrix moves relative to the tape.

12. A fiber optic cable according to claim 11, wherein the matrix is formed from elastomeric acrylate.

13. A fiber optic cable according to claim 11, wherein the tape is a fluoropolymer tape.

14. A fiber optic cable according to claim 11, wherein the tape is expanded polytetrafluoroethylene (ePTFE) tape.

15. A fiber optic cable according to claim 11, wherein the water swellable yarn includes
a polyester yarn,
a super-absorbent material, and
a binder.

16. A fiber optic cable according to claim 11, wherein the tube includes a flouropolymer.

17. A fiber optic cable according to claim 11, wherein the tube includes polyvinylidene fluoride (PVDF).

18. A fiber optic cable according to claim 11, wherein the strength member includes a plurality of aramid yarn.

19. A fiber optic cable according to claim 11, wherein the strength member is disposed with a lay length of approximately 90 mm (approximately 3.5 inches).

20. A fiber optic cable according to claim 11, wherein the jacket is made from any one of polyether-based thermoplastic polyurethane (TPU), polyvinylidene fluoride (PVDF), polyvinyl chloride (PVC), or halogen-free, fire-retardant, cable-sheathing compound.

21. A fiber optic cable, comprising:
a plurality of optical fibers;
a matrix substantially encasing the plurality of optical fibers, the matrix including an ultraviolet-curable elastomeric acrylate;
expanded polytetrafluoroethylene (ePTFE) tape substantially disposed around the matrix;
a tube substantially disposed around the expanded polytetrafluoroethylene tape, the tube including a fluoropolymer;
a strength member substantially disposed around the tube, the strength member including a plurality of aramid yarn substantially helically disposed on the tube; and
a jacket substantially on an outer periphery of the fiber optic cable.

22. A fiber optic cable according to claim 10, wherein the water swellable yarn includes,
a polyester yarn,
a super-absorbent material, and
a binder.
